(19) United States
(12) Patent Application Publication
(10) Pub. No.: US 2023/0200587 A1
(43) Pub. Date: Jun. 29, 2023

(54) Taco Shell Maker

(71) Applicant: Maricela Cueva, Azusa, CA (US)

(72) Inventor: Maricela Cueva, Azusa, CA (US)

(21) Appl. No.: 18/089,406

(22) Filed: Dec. 27, 2022

Related U.S. Application Data
(60) Provisional application No. 63/294,821, filed on Dec. 29, 2021.

(51) Int. Cl. A47J 37/12; A23L 5/10; A21D 13/42

(52) U.S. Cl. CPC A47J 37/1295; A23L 5/11; A21D 13/42

(57) ABSTRACT

A taco shell maker for holding tortillas during deep frying. The taco shell maker includes a generally round disk folded to create a body having two half round edges. Two opposing tabs are generally centered on the half round edges. The body is preferably a little larger than the tortillas made into the taco shells, for example ½ inch larger diameter than the tortillas before folding. The tabs are folded outward about 180 degrees to be generally parallel to the body. The tabs may include flared out ends to facilitate sliding an edge of the tortilla between the body and each tab. The taco shell maker further allows frying the taco shell in oil in a typical frying pan, not requiring a deep fryer and using much less oil than a deep fryer. The heat of the oil and pan allows the tortilla to contour to the taco shell maker.

### CROSS-REFERENCE TO RELATED APPLICATIONS

The present application claims the priority of U.S. Provisional Patent Application Ser. No. 63/294,821 filed Dec. 29, 2021, which application is incorporated in its entirety herein by reference.

### BACKGROUND OF THE INVENTION

The present invention relates to preparing taco shells and in particular to a utensil for holding a folded tortilla while making and frying a taco shell.

Tacos are a favorite meal world wide. Consumers enjoy tacos served as both soft tacos and in deep fried shells. Other utensil, including racks, have been used to hold the tortilla during deep frying but do not always provide the best result. The deep frying further requires a specialized cooking device and a substantial amount of oil, much of which oil is absorbed into the tortilla.

### BRIEF SUMMARY OF THE INVENTION

The present invention addresses the above and other needs by providing a utensil for holding tortillas during deep frying. The taco shell maker includes a generally round disk folded to create a body having two half round edges. The taco shell maker preferably includes two opposing tabs generally centered on the half round edges. The body is preferably a little larger than the tortillas made into the taco shells, for example ½ inch larger diameter than the tortillas before folding. The tabs are folded outward about 180 degrees to be generally parallel to the body. The tabs may include flared out ends to facilitate sliding an edge of the tortilla between the body and each tab. The taco shell maker further allows frying the taco shell in a typical frying pan, not requiring a deep fryer and using much less oil than a deep fryer.

In accordance with one aspect of the invention, there is provided a taco shell maker including tabs folded against the body for holding a tortilla against an outside surface of the body. Edges of the tortilla are inserted under the tabs to hold the tortilla for deep frying to make the taco shell. Including the tabs to hold the tortillas against the taco shell maker provides a desired taco shell shape. This process allows for the use of much less oil to fry the taco shells and is convenient to use.

A method for frying taco shells using the taco shell using a common frying pan. The tortilla may be attached to the taco shell maker and a first tortilla side fried in the frying pan and then a second tortilla side fried in the frying pan, not requiring a deep fryer or substantial oil.

### BRIEF DESCRIPTION OF THE SEVERAL VIEWS OF THE DRAWING

The above and other aspects, features and advantages of the present invention will be more apparent from the following more particular description thereof, presented in conjunction with the following drawings wherein:

FIG. 1 shows a taco shell maker before folding, according to the present invention.

FIG. 2 shows a perspective view of the taco shell maker after folding, according to the present invention.

FIG. 3A shows a side view of the taco shell maker after folding, according to the present invention.

FIG. 3B shows an end view of the taco shell maker after folding, according to the present invention.

FIG. 4 is a method according to the present invention.

Corresponding reference characters indicate corresponding components throughout the several views of the drawings.

### DETAILED DESCRIPTION OF THE INVENTION

The following description is of the best mode presently contemplated for carrying out the invention. This description is not to be taken in a limiting sense, but is made merely for the purpose of describing one or more preferred embodiments of the invention. The scope of the invention should be determined with reference to the claims.

Where the terms “about” or “generally” are associated with an element of the invention, it is intended to describe a feature's appearance to the human eye or human perception, and not a precise measurement, or typically within 10 percent of a stated value.

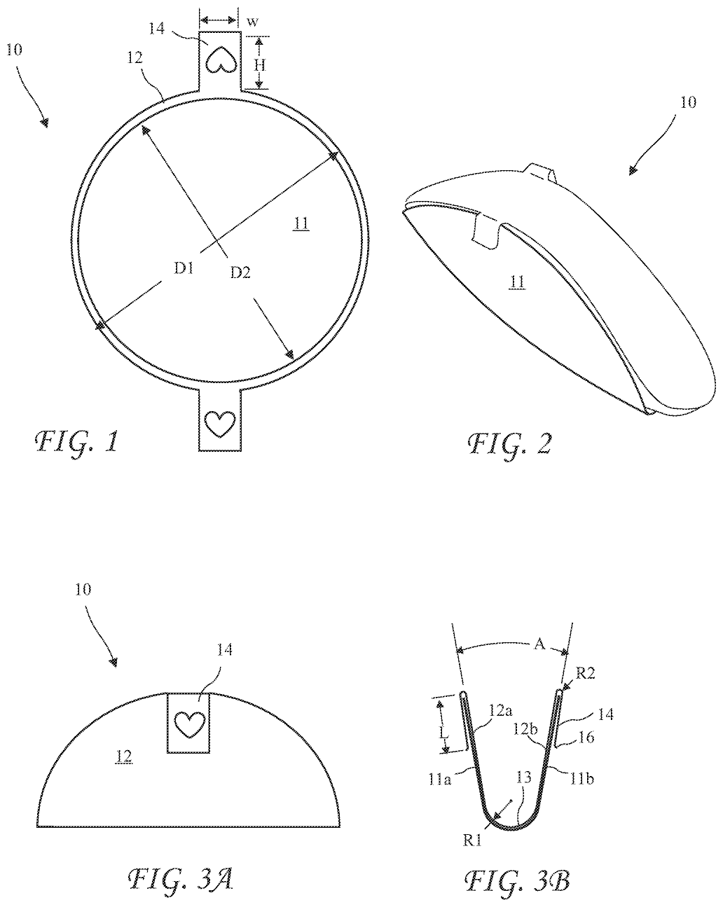

A taco shell maker 10 according to the present invention, before folding, and a tortilla 11, are shown in FIG. 1. The taco shell maker 10 includes a generally round body 12 including opposing tabs 14 reaching out from a generally round body 12. The generally round body 12 has a diameter D1 and the tabs 14 have heights H and widths W. The tortilla 11 has a diameter D2. The diameter D1 is preferably at least ¼ inch greater than the diameter D2 of tortillas used to make taco shells, and more preferably between ¼ and one inch greater than the diameter of tortillas used to make the taco shells, and most preferably ¼ inch greater than the diameter of tortillas used to make the taco shells. For example, for five inch diameter D2 tortillas the generally round body 12 diameter D1 is about 5¼ inches. The tab 14 height H is preferably between one and two inches before folding and more preferably about one inches before folding. The tab 14 width W is preferably between ⅜ and ¾ inches and more preferably about ¾ inches.

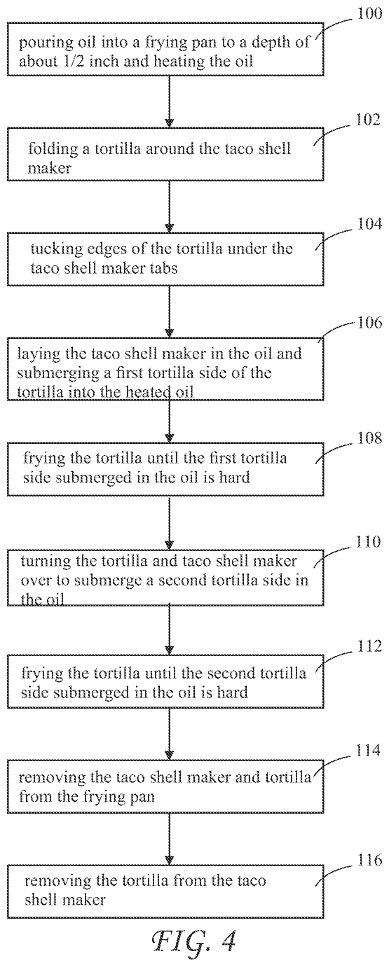

A perspective view of the taco shell maker 10 after folding the generally round body 12 into a “U” shape and a tortilla 11 is shown in FIG. 2, a side view of the taco shell maker 10 after folding is shown in FIG. 3A, and an end view of the taco shell maker 10 after folding the generally round body 12 into a “U” shape and folding the tabs 14 to be generally parallel with sides 12a and 12b, is shown in FIG. 3B. The taco shell maker 10 is folded to form a rounded “U” having an interior angle A between sides 12a and 12b of the body 12 and creating a rounded fold 13 having a radius R1. The interior angle A is preferably between 30 and 45 degrees, and more preferably about 40 degrees. The radius R1 is preferably between ¼ and 1 inch and more preferably about ½ inches. A first tortilla side 11a is shown under one of the tabs 14 and a second tortilla side 11b is shown under the opposite tab 14.

The tabs 14 have a fold radius R2 of preferably between 0.05 and 0.1 inches and more preferably about 0.8 inches and reach down generally parallel to the body sides 12a and 12b, and a length L of preferably between 0.69 and 0.84 inches and more preferably about 0.765 inch. The tabs 14 preferably include a flared out bottom edge 16 to facilitate insertion of edges of the tortilla 11 under the tabs 14.

A method for making taco shells using the taco shell maker 10 is described in FIG. 4. The method includes pouring oil into a frying pan to a depth of about ½ inch and heating the oil at step 100, folding a tortilla around the taco shell maker at step 102, tucking edges of the tortilla under the taco shell maker tabs at step 104, laying the taco shell maker in the oil and submerging a first tortilla side of the tortilla into the heated oil at step 106, frying the tortilla until the first tortilla side submerged in the oil is hard at step 108, turning the tortilla and taco shell maker over to submerge a second tortilla side in the oil at step 110, frying the tortilla until the second tortilla side submerged in the oil is hard at step 112, removing the taco shell maker and tortilla from the frying pan at step 114, and removing the tortilla from the taco shell maker at step 116. Turning and removing the tortilla and taco shell maker from the frying pan is preferably done using stainless steel utility tongs.

The taco shell maker 10 may be made of any food grade material and preferably stainless steel, aluminum, or silicone material, and more preferably a food grade stainless steel and most preferably 24 gauge 304 stainless steel.

While the invention herein disclosed has been described by means of specific embodiments and applications thereof, numerous modifications and variations could be made thereto by those skilled in the art without departing from the scope of the invention set forth in the claims.

I claim:

1. A taco shell maker, comprising:
a generally round body folded into a “U” shape; and
tabs reaching out from the generally round body at peaks of the “U” and bent back next to the generally round body.

2. The taco shell maker of claim 1, wherein the generally round body has a diameter D1 at least ¼ inches greater than the diameter D2 of tortillas used with the taco shell maker.

3. The taco shell maker of claim 2, wherein the generally round body has the diameter D1 of about 5¼ inches.

4. The taco shell maker of claim 2, wherein the tabs extend between one and two inches beyond the diameter D1 of the generally round body prior to bending the tabs next to the generally round body.

5. The taco shell maker of claim 4, wherein the tabs extend about one inch beyond the diameter D1 of the generally round body prior to bending the tabs next to the generally round body.

6. The taco shell maker of claim 4, wherein the tabs have a width W of between ⅜ and ¾ inches.

7. The taco shell maker of claim 6, wherein the tabs have the width W about ¾ inches.

8. The taco shell maker of claim 7, wherein:
the tabs extend about one inch beyond the diameter D of the generally round body prior to bending the tabs next to the generally round body; and
the tabs have the width W of about ¾ inches.

9. The taco shell maker of claim 8, wherein the tabs include a flared out bottom edge.

10. The taco shell maker of claim 1, wherein a rounded fold in the generally round body has a radius of between ¼ and 1 inch.

11. The taco shell maker of claim 10, wherein the rounded fold in the generally round body has a radius of about ½ inches.

12. The taco shell maker of claim 1, wherein the folded generally round body has an interior angle 30 and 45 degrees.

13. The taco shell maker of claim 12, wherein the folded generally round body has the interior angle of about 40 degrees.

14. A method for preparing a deep fried taco shell, the method comprising:
selecting a tortilla having a tortilla diameter D2;
selecting a folded taco shell maker made by folding a generally round body having a diameter D1 between ¼ and one inch greater than the tortilla diameter D2 of the tortilla, prior to folding the generally round body, and including a first tab and a second tab extending between one and two inches beyond the diameter D1 of the generally round body prior to bending the tabs next to the generally round body and a width W of between ⅜ and ¾ inches, the tabs folded against the generally round body;
pouring oil into a frying pan;
heating the frying pan;
laying a first side the tortilla against a first outside surface of the folded taco shell maker;
inserting a first edge of the first side of the tortilla under the first tab at a first peak of the first side of the folded taco shell maker;
folding a second side the tortilla around a rounded fold of the folded taco shell maker;
laying a second side the tortilla opposite to the first side against a second outside surface of the folded taco shell maker opposite to the first outside surface of the folded taco shell maker;
inserting a second edge of the second side of the tortilla under the second tab at a second peak of the second side of the folded taco shell maker; and
cooking the tortilla in the frying pan.

15. The method of claim 14, wherein pouring oil into the frying pan comprises pouring oil into the frying pan to a depth of about one half inch before cooking the tortilla.

16. The method of claim 14, wherein cooking the tortilla comprises:
laying the first side of the tortilla held by the folded taco shell maker into oil in a frying pan;
cooking the first side of the tortilla;
laying the second side of the tortilla held by the folded taco shell maker into the oil in the frying pan; and
cooking the second side of the tortilla.

17. A method for preparing a deep fried taco shell, the method comprising:
selecting a tortilla having a tortilla diameter D2;
selecting a taco shell maker comprising:
a generally round body folded into a “U” shape, the generally round body having a diameter D1 about ¼ inch greater than the tortilla diameter D2 of the tortilla before folding the generally round body into the “U” shape; and
first and second tabs reaching out from the generally round body at peaks of the “U” and bent back generally parallel to the generally round body
pouring oil into a frying pan to a depth of ½ inch;
heating the oil;
laying a first side the tortilla against a first outside surface of the folded taco shell maker;
inserting a first edge of the first side of the tortilla under the first tab at a first peak of the first side of the folded taco shell maker;
folding a second side the tortilla around a rounded fold of the folded taco shell maker;
laying a second side the tortilla opposite to the first side against a second outside surface of the folded taco shell maker opposite to the first outside surface of the folded taco shell maker;
inserting a second edge of the second side of the tortilla under the second tab at a second peak of the second side of the folded taco shell maker;
laying the taco shell maker in the oil and submerging a first tortilla side of the tortilla into the heated oil;
frying the tortilla until the first tortilla side submerged in the oil is hard;
turning the tortilla and taco shell maker over using stainless steel utility tongs to submerge a second tortilla side in the oil;
frying the tortilla until the second tortilla side submerged in the oil is hard;
removing the taco shell maker and tortilla from the frying pan using the stainless steel utility tongs; and
removing the tortilla from the taco shell maker.
